(19) United States
(12) Patent Application Publication
(10) Pub. No.: US 2022/0405832 A1
(43) Pub. Date: Dec. 22, 2022

(54) ONLINE INTEGRATED RENTAL AND PURCHASE SYSTEM FOR PRODUCTS

(71) Applicant: HOWARD CHAO, TORONTO (CA)

(72) Inventor: HOWARD CHAO, TORONTO (CA)

(21) Appl. No.: 17/763,897

(22) PCT Filed: Sep. 28, 2020
(86) PCT No.: PCT/CA2020/051291

§ 371 Date: Mar. 25, 2022

Related U.S. Application Data
(60) Provisional application No. 62/906,511, filed on Sep. 26, 2019.

(51) Int. Cl. G06Q 30/06; G06Q 10/08; G06Q 10/02; G06Q 30/02

(52) U.S. Cl. CPC G06Q 30/0645; G06Q 10/087; G06Q 30/0635; G06Q 10/0837; G06Q 10/02; G06Q 30/0233; G06Q 30/0231; G06Q 30/0217

(57) ABSTRACT

An integrated system is designed to provide the user with a streamlined process for rentals and also the option to purchase Products after providing information on both options all in one online platform. The system allows users easy access to rental information and to easily find single or multiple Products suitable for their needs for a requested date or dates, allowing users to create rental reservations and providing users with rental options before the rentals start, as well as during the rental period. The system provides the user with the ability to make future rental reservations of a single or multiple Products and provides availability information on a single or multiple Products in order to rent at a selected date or dates a combination of Products that may or may not be dependable on each other (i.e. one Product is required to use some other Products), which may require the rental of these Products to be made during the same rental period. The system also provides an optional checklist for each rented Product, consisting of a list of components or actions to do, allowing users to ensure that no components are missing or damaged and that the Products are returned in the same manner as delivered so the Products are in a rentable manner for the next rental reservation. The system splits several aspects, such as Wish List, Cart and Reservations, distinctively between rentals and purchases, so users can track all activities by rentals or purchases. The system also offers membership point system that can be redeemed for rentals or purchases, as well as rental extensions.

### FIELD

The present disclosure relates to and online integrated rental and purchase system for products, and more particularly the present disclosure relates to an online integrated board game rental and purchase system.

### BACKGROUND

With board games or other products (“products’) having multiple components, which can be complex and significant in number, rentability of these products have been a challenge and significantly difficult to manage. In particular, with respect to board games, there are thousands of them on the market and the cost of each can easily vary between $50 to hundreds of dollars each to purchase. For a great many people playing board games is a favorite past time and so purchasing a lot of board games for variety can be very expensive. In addition, a great many board games have what are called dependable board games, such as add-ons or expansions, which require the base board game to play the dependable board game. Thus the cost of purchasing such sets of related board games can be quite prohibitive. Holding a large collection of board games can also be space consuming.

Thus it would be very advantageous to provide an online integrated rental and purchase system for products, and more particularly a board game rental and purchase system to allow board game fans to easily rent board games at the comfort of their home, be able to try a large variety of board games and to have the option of choosing whether to continue renting a board game or purchasing it if they enjoyed it.

### SUMMARY

The present disclosure provides an integrated system that is designed to provide the user with a streamlined process for rentals and also the option to purchase products after providing information on both options all in one online platform. The system allows users easy access to rental information and to easily find single or multiple products suitable for their needs for a requested date or dates, allowing users to create rental reservations and providing users with rental options before the rentals start, as well as during the rental period. The system provides the user with the ability to make future rental reservations of a single or multiple products and provides availability information on a single or multiple products in order to rent at a selected date or dates a combination of products that may or may not be dependable on each other (i.e. one product is required to use some other products), which may require the rental of these products to be made during the same rental period. The system also provides an optional checklist for each rented product, consisting of a list of components or actions to do, allowing users to ensure that no components are missing or damaged and that the products are returned in the same manner as delivered so the products are in a rentable manner for the next rental reservation. The system splits several aspects, such as Wish List, Cart and Reservations, distinctively between rentals and purchases, so users can track all activities by rentals or purchases. The system also offers membership point system that can be redeemed for rentals or purchases, as well as rental extensions.

Thus, in one aspect the present disclosure provides an online integrated rental and purchase system for products, comprising:

a storage facility for the products;

a computer system and data base comprising a memory with an inventory of products available for rent and/or purchase stored thereon;

the computer system is accessible online by a mobile application and online by remote computers via a website and being programmed to
permit browsing of the inventory of products by different categories and criteria,
accept user inputs related to preferred date or dates for rental of desired products,
display availability of each product for rental on the preferred date or dates and availability for purchase,
display availability of related or dependable products, if any, to each product, such as add-ons that require the “base” product to use the related or dependable products, for rental on the preferred date or dates for ability to rent several products together,
accept user inputs to either rent or purchase the desired products for a selected rental period if the products are available on the selected date or dates for the selected rental period or if the products are available for purchase,
accept user inputs to provide address, method and timeframe to which the rented or purchased products which are selected are to be delivered to and address, method and timeframe to which the rented products which are selected are to be picked up for return purposes;
accept user inputs to provide credit card information to pay to rent or purchase products or for deposit purposes for the rented products, for which the deposit amount may or may not be charged partially or in full;
in the case one or more products have been selected for rental, add the selected products to a rental cart and in the case one or more products have been selected for purchase, add the selected products to a purchase cart;
display user's carts split by rental cart and purchase cart;

upon acceptance of user inputs to either rent or purchase the desired products, update the inventory of products available for rent for the selected date or dates and/or purchase stored thereon;

communicate with a designated product delivery service either internal or external to retrieve the selected products from the product storage facility and deliver the selected products to the user's selected address by the selected reservation date for rentals or delivery date for purchases with the selected method and timeframe, and to pick up the products after the rental period at the user's selected address with the selected method and timeframe; and

update the inventory of products available for rent once the products have been returned to the storage facility.

The computer system may be programmed to
provide a wish list to provide users dual options to add a selected product to the wish list for rental purposes with a requested reservation date or dates or for purchase purposes,
notify the user when a product in the wish list for rental purposes becomes available for rental at the requested date or dates or when a product in the wish list for purchase purposes becomes available for purchase, and
accept user input to add the products in wish list to either the rental or purchase cart when the products become available at the requested date or dates for rental or available for purchase and accept user's input to either rent or purchase the products in wish list.

The computer system may be programmed to
display, once one or more products have been selected for rent or purchase, a list of “warnings” detailing specific requirements, if any, of the selected products,
prompt the user to acknowledge these “warnings” before being able to complete the checkout process,
allow users to create rental reservations to rent products and/or purchase reservations to purchase products,
allow users, upon finalizing rental of one or more products and checking out, to either make a new rental reservation, add the rented products to a pending rental reservation, if any, or to add the rented products to an ongoing rental reservation, if any, wherein the process of checking out differs depending on the choice selected by the user. Pending rental reservation is defined as a rental reservation that has not started yet while ongoing rental reservation is defined as a rental reservation that has started. The rental reservation will start on the first selected date of the rental reservation,
allow users, upon finalizing purchase of one or more products and check out, to either make a new purchase reservation or add the purchased products to a pending purchase reservation, if any, wherein the process of checking out differs depending on the choice selected by the user. Pending purchase reservation is defined as a purchase reservation whose delivery process has not been initiated yet on the requested delivery date,
display users' reservations split by rental reservations and purchase reservations, and also by past or completed reservations, and
allow the user in the rental or purchase reservation to modify the address, method and timeframe for delivery or return purposes, remove or change amount of board games, to cancel the reservation, to view receipt of the reservation, to leave a tip and to end the rental reservation.

The computer system may be programmed to
display in a calendar with the combined availability of all products added to the rental cart in order to allow the user to select a date that will allow the user to rent all products selected by the user in the rental cart,
accept user input to select products that are or are not currently available at the selected date and duration to rent, and thereafter search the calendar of combined availability to select a reservation date or dates that results in all products being available, and
allow the user to modify the reservation date of the rented products in a pending rental reservation, and before a modification is made, display a calendar with the combined availability of all products in the rental reservation to show alternate reservation dates possible for the user to choose to rent the selected products.

The computer system may be programmed to
calculate and assign membership points to the user based on a predetermined formula for calculating membership points,
display status of user's membership points, such as outstanding membership points, redeemed membership points and earned/credited membership points,
display available reservation dates following the last date of a rental reservation and allow the user to extend the rental reservation if available, wherein the availability of extension is based on the availability of rental inventory of each product in the rental reservation, as well as existing reservations that contain at least one of the products in the user's rental reservation and whose reservation period overlaps the user's rental reservation requested date or dates for extension,
provide an option of paying directly for the extension of time by paying the extension of time fee or by redeeming membership points, if sufficient membership points where the amount of membership points required to redeem the extension of time is displayed with user's outstanding membership points, and
updated dates and receipt in the rental reservation after extension has been finalized.

The computer system may be programmed to
display an interactive checklist for each product in the rental reservation which includes a list of items that represent all components of the product and each item is described with an “amount”, a “description” and a “location”,
providing a list of actions in the checklist that the user can optionally take prior to the end of the rental reservation,
allow the user to fill the checklist by selecting one of the status designations available for each of the items or the actions, such as “Complete”, “Missing”, “Damaged” or “Done”,
upon the user completing the entire checklist including a status entered for each item and action, assigning the user bonus membership points or other forms of bonus or rewards, and
upon receipt of the checklist filled out by the user, send an internal notification about missing or damaged items or other issues for timely replacement of the missing or damaged items or any parts before the next reservation, if possible.

The present disclosure also provides an online integrated board game rental and purchase system, comprising:

a board game storage facility;

a computer system and data base comprising a memory with an inventory of board games available for rent and/or purchase stored thereon;

the computer system is accessible online by a mobile application and online by remote computers via a website and being programmed to
permit browsing of the inventory of board games by different categories and criteria,
accept user inputs related to preferred date or dates for rental of desired board games,
display availability of each board game for rental on the preferred date or dates and availability for purchase,
display availability of related or dependable board games, if any, to each board game, such as add-ons or expansions that require the “base” board game, for rental on the preferred date or dates for ability to rent several board games together,
accept user inputs to either rent or purchase the desired board games for a selected rental period if the board games are available on the selected date or dates for the selected rental period or if the board games are available for purchase,
accept user inputs to provide address, method and timeframe to which the rented or purchased board games which are selected are to be delivered to and address, method and timeframe to which the rented board games which are selected are to be picked up for return purposes;
accept user inputs to provide credit card information to pay to rent or purchase board games or for deposit purposes for the rented board games, for which the deposit amount may or may not be charged partially or in full;
in the case one or more board games have been selected for rental, add the selected board games to a rental cart and in the case one or more board games have been selected for purchase, add the selected board games to a purchase cart;
display user's carts split by rental cart and purchase cart;

upon acceptance of user inputs to either rent or purchase the desired board games, update the inventory of board games available for rent for the selected date or dates and/or purchase stored thereon;

communicate with a designated board game delivery service either internal or external to retrieve the selected board games from the board game storage facility and deliver the selected board games to the user's selected address by the selected reservation date for rentals or delivery date for purchases with the selected method and timeframe, and to pick up the board games after the rental period at the user's selected address with the selected method and timeframe; and

update the inventory of board games available for rent once the board games have been returned to the board game storage facility.

The computer system may be programmed to provide a wish list to provide users dual options to add a selected board game to the wish list for rental purposes with a requested reservation date or dates or for purchase purposes, notify the user when a board game in the wish list for rental purposes becomes available for rental at the requested date or dates or when a board game in the wish list for purchase purposes becomes available for purchase, and accept user input to add the board games in wish list to either the rental or purchase cart when the board games become available at the requested date or dates for rental or available for purchase and accept user's input to either rent or purchase the board games in wish list.

The computer system may be programmed to allow users to create rental reservations to rent board games and/or purchase reservations to purchase board games, and display users' reservations split by rental reservations and purchase reservations, and also by past or completed reservations.

The computer system may be programmed to allow the user in the rental or purchase reservation to modify the address, method and timeframe for delivery or return purposes, remove or change amount of board games, to cancel the reservation, to view receipt of the reservation, to leave a tip and to end the rental reservation.

The computer system may be programmed to display calendars and allowing the user input to select a reservation date and duration, which determines the requested rental date or dates, display the rental availability while browsing based on the requested rental date or dates, and upon change of the reservation date and/or duration on any rental calendar, update all rental calendars using the selected reservation date and duration, update the rental availability when browsing through the board games based on the new requested date or dates, wherein the rental availability of each individual board game depends on the available rental inventory of that board game and existing rental reservations containing that board game that have an overlapping rental period as the requested rental date or dates of the user.

The computer system may be programmed to display in a calendar with the combined availability of all board games added to the rental cart in order to allow the user to select a date that will allow the user to rent all board games selected by the user in the rental cart, and accept user input to select board games that are or are not currently available at the selected date and duration to rent, and thereafter search the calendar of combined availability to select a reservation date or dates that results in all board games being available.

The computer system may be programmed to allow users, upon finalizing rental of one or more board games and checking out, to either make a new rental reservation, add the rented board games to a pending rental reservation, if any, or to add the rented board games to an ongoing rental reservation, if any, wherein the process of checking out differs depending on the choice selected by the user where ending rental reservation is defined as a rental reservation that has not started yet while ongoing rental reservation is defined as a rental reservation that has started. The computer system may be programmed to allow users, upon finalizing purchase of one or more board games and check out, to either make a new purchase reservation or add the purchased board games to a pending purchase reservation, if any, wherein the process of checking out differs depending on the choice selected by the user. Pending purchase reservation is defined as a purchase reservation whose delivery process has not been initiated yet on the requested delivery date.

The computer system may be programmed to display, once one or more board games have been selected for rent or purchase, a list of “warnings” detailing specific requirements, if any, of the selected board games, and prompt the user to acknowledge these “warnings” before being able to complete the checkout process.

The computer system may be programmed to allow the user to modify the reservation date of the rented board games in a pending rental reservation, and before a modification is made, display a calendar with the combined availability of all board games in the rental reservation to show alternate reservation dates possible for the user to choose to rent the selected board games.

The computer system may be programmed to calculate and assign membership points to the user based on a predetermined formula for calculating membership points, display status of user's membership points, such as outstanding membership points, redeemed membership points and earned/credited membership points, display available reservation dates following the last date of a rental reservation and allow the user to extend the rental reservation if available, wherein the availability of extension is based on the availability of rental inventory of each board game in the rental reservation, as well as existing reservations that contain at least one of the board games in the user's rental reservation and whose reservation period overlaps the user's rental reservation requested date or dates for extension, provide an option of paying directly for the extension of time by paying the extension of time fee or by redeeming membership points, if sufficient membership points where the amount of membership points required to redeem the extension of time is displayed with user's outstanding membership points, and update dates and receipt in the rental reservation after extension has been finalized.

The computer system may be programmed to
display an interactive checklist for each board game in the rental reservation which includes a list of items that represent all components of the board game and each item is described with an “amount”, a “description” and a “location”,
providing a list of actions in the checklist that the user can optionally take prior to the end of the rental reservation,
allow the user to fill the checklist by selecting one of the status designations available for each of the items or the actions, such as “Complete”, “Missing”, “Damaged” or “Done”, and
upon the user completing the entire checklist including a status entered for each item and action, assigning the user bonus membership points or other forms of bonus or rewards.

The computer system may be programmed to
upon receipt of the checklist filled out by the user, send an internal notification about missing or damaged items or other issues for timely replacement of the missing or damaged items or any parts before the next reservation, if possible.

The online integrated board game rental and purchase system may be accessible by a mobile application downloadable onto smart devices connected to the internet.

A further understanding of the functional and advantageous aspects of the invention can be realized by reference to the following detailed description and drawings.

### BRIEF DESCRIPTION OF THE DRAWINGS

Embodiments disclosed herein will be more fully understood from the following detailed description thereof taken in connection with the accompanying drawings, which form a part of this application, and in which:

FIG. 1 is a flow chart showing the steps involved in reserving, or purchasing, or both and checking out using the present online board game reservation method and system.

FIG. 2 is a flow chart showing the pending reservation features and date modification feature forming part of the present online board game reservation method and system.

FIG. 3 is a flow chart showing the ongoing reservation features, including the extension and checklist forming part of the present online board game reservation method and system.

FIG. 4 is a flow chart showing the steps for the reservation method and system to produce a board game rental or purchase wish list forming part of the present online board game reservation method and system.

FIG. 5 is a diagram of an example computer system to be used to implement the present online integrated rental and purchase system for products.

### DETAILED DESCRIPTION

Without limitation, the majority of the systems described herein are directed to board game rental platform mobile applications. As required, embodiments of the present invention are disclosed herein. However, the disclosed embodiments are merely exemplary, and it should be understood that the invention may be embodied in many various and alternative forms.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

The present disclosure provides an online integrated rental and purchase system for products. The system includes a storage facility for the products and a computer system and data base comprising a memory with an inventory of products available for rent and/or purchase stored thereon. The computer system is accessible online by a mobile application and online by remote computers via a website and being programmed to 1) permit browsing of the inventory of products by different categories and criteria, 2) accept user inputs related to preferred date or dates for rental or purchase of desired products, 3) display availability of each product for rental on the preferred date or dates and availability for purchase, 4) display availability of related or dependable products, if any, to each product, such as add-ons that requires the “base” product to use the related or dependable products, for rental on the preferred date or dates for ability to rent several products together, 5) accept user inputs to either rent or purchase the desired products for a selected rental period if the products are available on the selected date or dates for the selected rental period or if the products are available for purchase, 6) accept user inputs to provide address, method and timeframe to which the rented or purchased products which are selected are to be delivered to and address, method and timeframe to which the rented products which are selected are to be picked up for return purposes, 7) accept user inputs to provide credit card information to pay to rent or purchase products or for deposit purposes for the rented products, for which the deposit amount may or may not be charged partially or in full, 8) in the case one or more products have been selected for rental, add the selected products to a rental cart and in the case one or more products have been selected for purchase, add the selected products to a purchase cart, and display user's carts split by rental cart and purchase cart.

Upon acceptance of user inputs to either rent or purchase the desired products, the computer system is programmed to update the inventory of products available for rent for the selected date or dates and/or purchase stored thereon and communicate with a designated product delivery service either internal or external to retrieve the selected products from the product storage facility and deliver the selected products to the user's selected address by the selected reservation date for rentals or delivery date for purchases with the selected method and timeframe, and to pick up the products after the rental period at the user's selected address with the selected method and timeframe. The computer system is programmed with instructions to update the inventory of products available for rent once the products have been returned to the storage facility.

The computer system is programmed with instructions to provide a wish list to provide users dual options to add a selected product to the wish list for rental purposes with a requested reservation date or dates or for purchase purposes, then notify the user when a product in the wish list for rental purposes becomes available for rental at the requested date or dates or when a product in the wish list for purchase purposes becomes available for purchase, and accept user input to add the products in wish list to either the rental or purchase cart when the products become available at the requested date or dates for rental or available for purchase and accept user's input to either rent or purchase the products in wish list.

The computer system is programmed with instructions to display, once one or more products have been selected for rent or purchase, a list of “warnings” detailing specific requirements, if any, of the selected products, and prompt the user to acknowledge these “warnings” before being able to complete the checkout process,

allow users to create rental reservations to rent products and/or purchase reservations to purchase products, and allow users, upon finalizing rental of one or more products and checking out, to either make a new rental reservation, add the rented products to a pending rental reservation, if any, or to add the rented products to an ongoing rental reservation, if any, wherein the process of checking out differs depending on the choice selected by the user. A pending rental reservation is defined as a rental reservation that has not started yet while ongoing rental reservation is defined as a rental reservation that has started.

The rental reservation will start on the first selected date of the rental reservation, and allow users, upon finalizing purchase of one or more products and check out, to either make a new purchase reservation or add the purchased products to a pending purchase reservation, if any, wherein the process of checking out differs depending on the choice selected by the user. Pending purchase reservation is defined as a purchase reservation whose delivery process has not been initiated yet on the requested delivery date. The computer system is programmed with instructions to display users' reservations split by rental reservations and purchase reservations, and also by past or completed reservations, and allow the user in the rental or purchase reservation to modify the address, method and timeframe for delivery or return purposes, remove or change amount of board games, to cancel the reservation, to view receipt of the reservation, to leave a tip and to end the rental reservation.

The computer system is programmed with instructions to display in a calendar the combined availability of all products added to the rental cart in order to allow the user to select a date that will allow the user to rent all products selected by the user in the rental cart, and to accept user input to select products that are or are not currently available at the selected date and duration to rent, and thereafter search the calendar of combined availability to select a reservation date or dates that results in all products being available, and then to allow the user to modify the reservation date of the rented products in a pending rental reservation, and before a modification is made, display a calendar with the combined availability of all products in the rental reservation to show alternate reservation dates possible for the user to choose to rent the selected products.

The computer system is programmed with instructions to calculate and assign membership points to the user based on a predetermined formula for calculating membership points, display status of user's membership points, such as outstanding membership points, redeemed membership points and earned/credited membership points. The computer system is programmed with instructions to display available reservation dates following the last date of a rental reservation and allow the user to extend the rental reservation if available, wherein the availability of extension is based on the availability of rental inventory of each product in the rental reservation, as well as existing reservations that contain at least one of the products in the user's rental reservation and whose reservation period overlaps the user's rental reservation requested date or dates for extension. The computer system is programmed to provide an option of paying directly for the extension of time by paying the extension of time fee or by redeeming membership points, and if sufficient membership points where the amount of membership points required to redeem the extension of time is displayed with the user's outstanding membership points. The system is configured with instructions to display updated dates and receipt in the rental reservation after extension has been finalized.

The computer system is programmed with instructions to display an interactive checklist for each product in the rental reservation which includes a list of items that represent all components of the product and each item is described with an “amount”, a “description” and a “location”, provide a list of actions in the checklist that the user can optionally take prior to the end of the rental reservation, allow the user to fill the checklist by selecting one of the status designations available for each of the items or the actions, such as “Complete”, “Missing”, “Damaged” or “Done”, and upon the user completing the entire checklist including a status entered for each item and action, assigning the user bonus membership points or other forms of bonus or rewards. Upon receipt of the checklist filled out by the user, the computer system is programmed with instructions to send an internal notification about missing or damaged items or other issues for timely replacement of the missing or damaged items or any parts before the next reservation, if possible.

The present disclosure will now be illustrated with a non-limiting example where the products are board games to be rented and/or purchased online through a mobile application.

### Example

The present mobile application is a board game rental platform that allows users to easily navigate through different rental products and to create reservations for rental purposes, which is the main focus of the mobile application. The mobile application is however also fully integrated to provide both rental and purchase options to the user. The mobile application simplifies the rental and return verification process by providing numerous board game rental options and customized checklists to ensure board games are returned in an easy to verify and re-rentable manner. The mobile application also allows users to easily know if a board game requires other board game(s) to play or which ones are available to be combined with the selected board game. The mobile application can be extended for rental of any types of products containing multiple components or that require specific steps prior to returning the products. The rentable products may also have specific requirements in order for the user to be able to use it. The products may have optional products that can be rented together (add-ons) or may require specific products. For example, you may require Product A and B in order to be able to use Product C. If Product C is rented, the user either needs to also rent Product A and B or have in their possession Product A and B already.

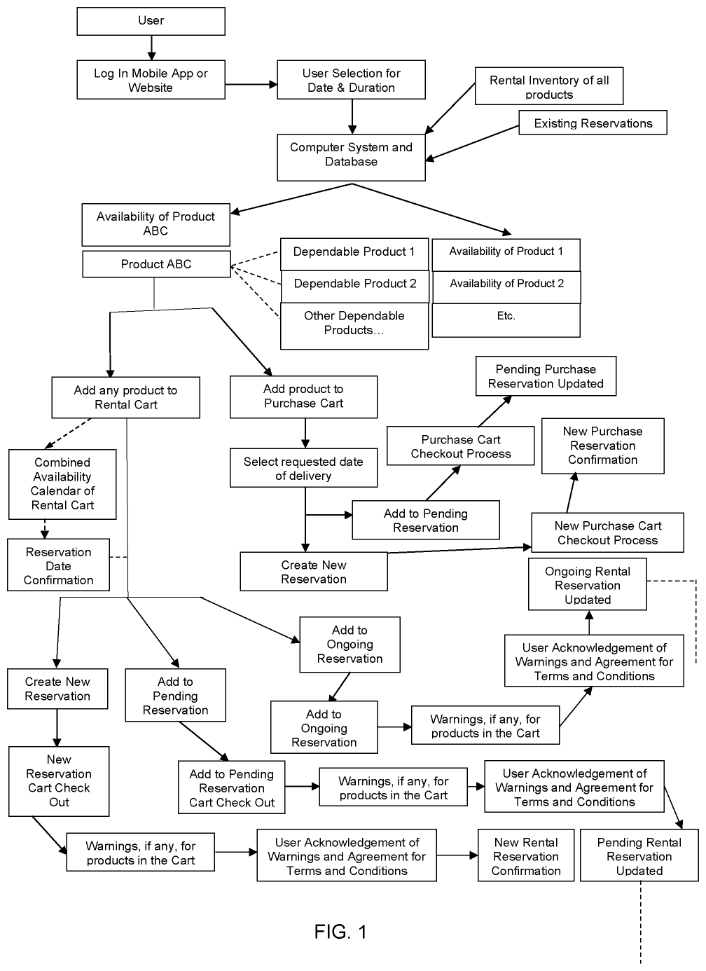

FIG. 1 is a flow chart showing the steps involved in reserving, or purchasing, or both and checking out using the present online board game reservation method and system. The rental availability shown for each board game in the mobile application is based on a starting date and duration selected by the user using a calendar accessible at the top of each rental page or using a floating yellow calendar icon. The selected date and duration, which determines the preferred date or dates for rental reservation, are maintained for all pages throughout the mobile application and the availability shown on all rental pages is based on the selected date and duration.

When the user modifies the date and/or duration, the availability of board games shown on all rental pages will be updated to the new date and duration. The availability of each board game for the next 4 months is also shown in the Detailed Information page of the board game, as well as the rental pricing for each duration. The individual availability status of each board game is based on inventory available for rental purposes and future reservations made by other users. In the Detailed Information page, if relevant, the user will also be able to see a list of all related board games (expansions or add-ons of that board game, or other related board games) and their availability for the selected date and duration so that it can be rented together.

Users are able to add board games to the Rental Cart whether they are available or not. The user can then go to the Rental Cart and access a calendar that will show the combined availability of all board games in the Rental Cart in order to find a date to rent them all (i.e. dates are shown in green if all board games in the Rental Cart are availability and red if not). The combined availability of the board games in the Rental Cart is based on the availability of each individual board game as explained previously. The combined availability shown in the Rental Cart is either the daily availability of the combined board games in the Rental Cart (for a 3 Night Reservation, user will need to select a reservation date that is green and the following two days must be green too) or the availability for the selected duration (a date in green means available for the selected duration so user can select any green date).

Once the reservation date has been confirmed or if all board games in the Rental Cart are already available, the users can checkout of the Rental Cart and select one of the three following options: 1. Create a new reservation; 2. Add to Pending Reservation; or 3. Add to Ongoing Reservation. Depending on the option selected by the users, the checkout process will differ. In the case of the Purchase Cart, users will be able to select one of the two following options: 1. Create a new Reservation; or 2. Add to Pending Reservation. Before the checkout process is completed for either the Rental or Purchase Cart and prior to a Reservation being created (option 1) or updated (option 2 or 3), a list of “Warnings”, if any, will appear to specify any requirements that some of the board games may have. The user will need to acknowledge these “Warnings” before being able to finalize the checkout process.

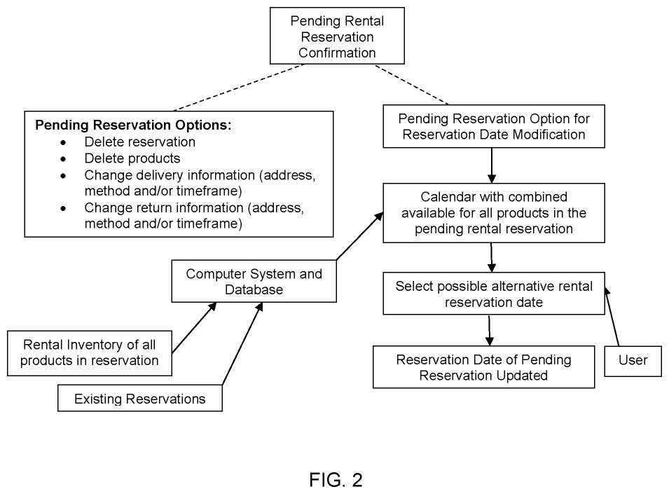

FIG. 2 is a flow chart showing the pending reservation features and date modification feature forming part of the present online board game reservation method and system. Before a rental reservation starts (i.e. pending rental reservations), users are able to access their rental reservation in the “Reservations” tab and change the starting date of their reservation. When choosing another starting date, the calendar will display the combined availability of all board games in the rental reservations to allow the user to choose an alternative date where all board games in the rental reservation are available (similar to the Rental Cart feature, but instead of the availability of all products in the Rental Cart, it is the availability of all products in the rental reservation). The combined availability shown is either the daily availability of the combined board games in the rental reservation (for a 3 Night Reservation, user will need to select a reservation date that is green and the following two days must be green too) or the availability for the selected duration (a date in green means available for the selected duration so user can click on any green date). If a possible alternative rental reservation date has been selected and confirmed, the reservation date of the pending rental reservation will be updated. Besides modifying the reservation date of a pending reservation, users will be given other options for pending reservations, such as modifying the address, method and timeframe for delivery or return purposes, removing or changing amount of board games, cancelling the reservation and viewing the receipt of the reservation.

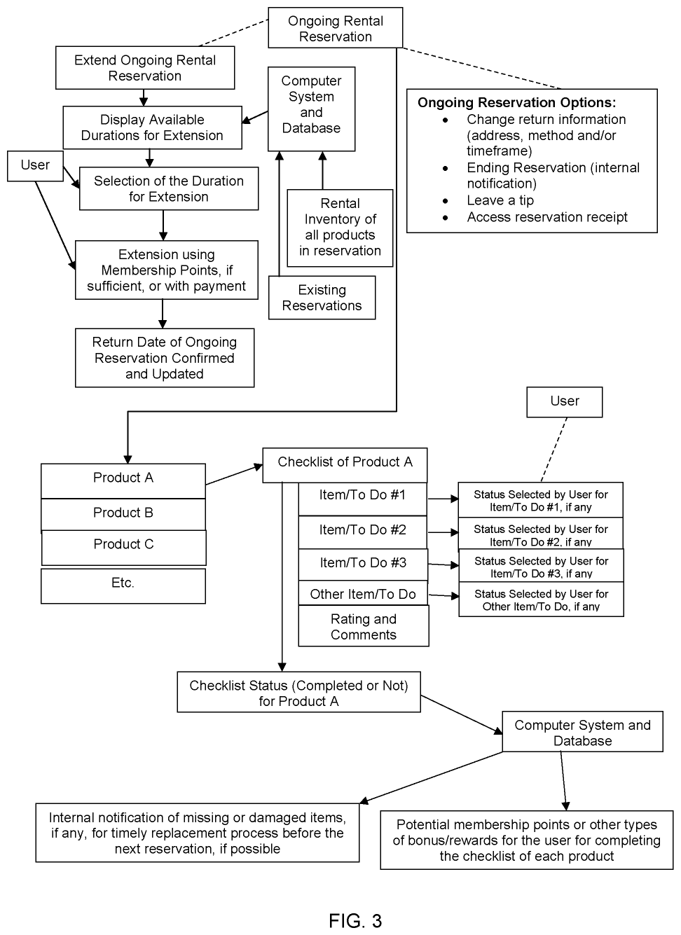

FIG. 3 is a flow chart showing the ongoing reservation features, extension and checklist forming part of the present online board game reservation method and system.

For ongoing reservations, users will have the option of extending the time of their rental reservation. The computer system will display available reservation dates following the last date of a rental reservation and allow the user to extend the rental reservation if available, wherein the availability of extension is based on the availability of rental inventory of each product in the rental reservation, as well as existing reservations that contain at least one of the products in the user's rental reservation and whose reservation period overlaps the user's rental reservation requested date or dates for extension. The computer system is programmed to provide an option of paying directly for the extension of time by paying the extension of time fee or by redeeming membership points, and if sufficient membership points where the amount of membership points required to redeem the extension of time is displayed with the user's outstanding membership points. Once the extension of time is confirmed, the dates and the receipt of the ongoing rental reservation will be updated

In an ongoing rental reservation, an interactive checklist for each product will also be displayed in the rental reservation which includes a list of items that represent all components of the product and each item is described with an “amount”, a “description” and a “location”, provide a list of actions in the checklist that the user can optionally take prior to the end of the rental reservation, allow the user to fill the checklist by selecting one of the status designations available for each of the items or the actions, such as “Complete”, “Missing”, “Damaged” or “Done”, and upon the user completing the entire checklist including a status entered for each item and action, assigning the user bonus membership points or other forms of bonus or rewards. Upon receipt of the checklist filled out by the user, the computer system will send an internal notification about missing or damaged items or other issues for timely replacement of the missing or damaged items or any parts before the next reservation, if possible.

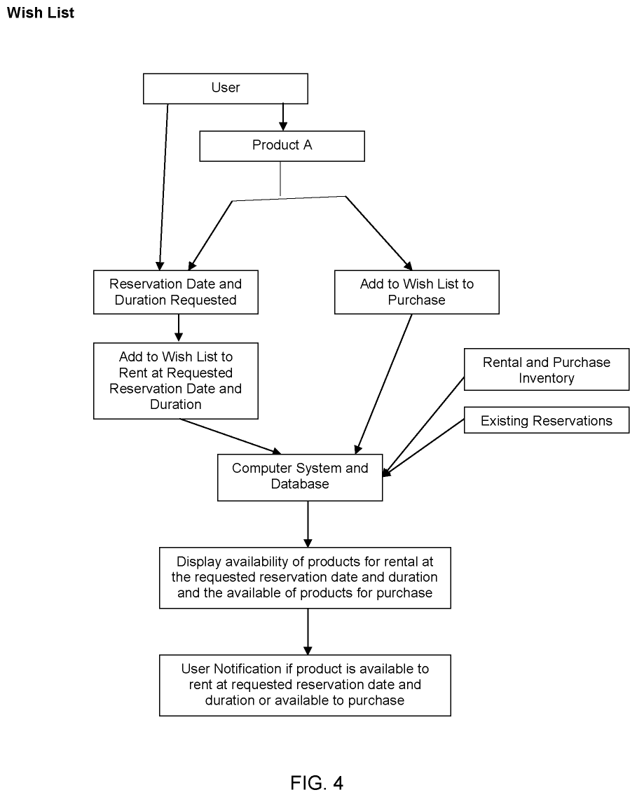

FIG. 4 is a flow chart showing the steps for the reservation method and system to produce a board game rental or purchase wish list forming part of the present online board game reservation method and system. Users will have the dual options to add a selected board game to a wish list for rental purposes with a requested reservation date or dates or for purchase purposes. Users can access their wish list to see the availability of the products for rental purposes and availability of the products for purchase purposes. Users will be notified the user when a board game in the wish list for rental purposes becomes available for rental at the requested date or dates or when a board game in the wish list for purchase purposes becomes available for purchase.

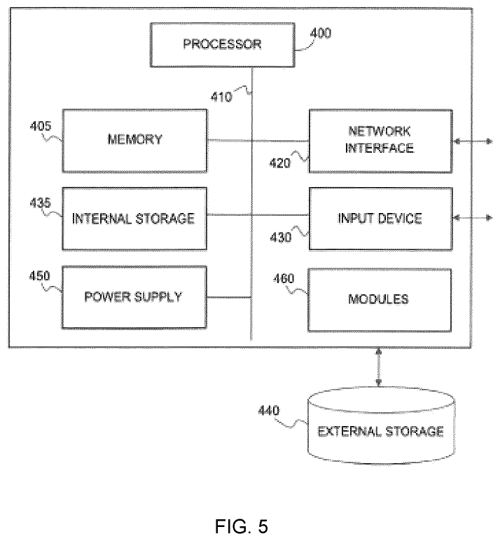

Referring to FIG. 5, the computer system forming part of the present online integrated rental and purchase system for products may be comprised of any suitable computing device, such as a personal computer, rack-mounted computing equipment, or a specialty purpose computing device. FIG. 5 illustrates one example implementation of a computer system including hardware such as a processor 400, memory 405, bus 410, network interface 420, input device 430, internal storage 435, optional external storage device 440 (e.g. a database server for storing information, such as information on products, users and reservations), and power supply 450.

While some embodiments can be implemented in fully functioning computers and computer systems, various embodiments are capable of being distributed as a computing product in a variety of forms and are capable of being applied regardless of the particular type of machine or computer readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

A computer readable storage medium can be used to store software and data which when executed by a data processing system causes the system to perform various methods. The executable software and data may be stored in various places including for example ROM, volatile RAM, nonvolatile memory and/or cache. Portions of this software and/or data may be stored in any one of these storage devices. As used herein, the phrases “computer readable material” and “computer readable storage medium” refers to all computer-readable media, except for a transitory propagating signal per se.

While the proposed method described herein are in conjunction with various embodiments for illustrative purposes, it is not intended that the proposed method be limited to such embodiments. On the contrary, the proposed method described and illustrated herein encompass various alternatives, modifications, and equivalents, without departing from the embodiments, the general scope of which is defined in the appended claims.

1. An online integrated board game rental and purchase system, comprising:
a board game storage facility;
a computer system and data base comprising a memory with an inventory of board games available for rent and/or purchase stored thereon;
the computer system, which is accessible online by a mobile application and online by remote computers via a website and being programmed to
permit browsing of the inventory of board games by different categories and criteria,
accept user inputs related to preferred date or dates for rental of desired board games,
display availability of each board game for rental on the preferred date or dates and availability for purchase,
display availability of related or dependable products, if any, to each product, such as add-ons that require the “base” product to use the related or dependable products, for rental on the preferred date or dates for ability to rent several products together,
accept user inputs to either rent or purchase the desired board games for a selected rental period if the board games are available on the selected date or dates for the selected rental period or if the board games are available for purchase,
accept user inputs to provide address, method and timeframe to which the rented or purchased board games which are selected are to be delivered to and address, method and timeframe to which the rented board games which are selected are to be picked up for return purposes;
accept user inputs to provide credit card information to pay to rent or purchase board games or for deposit purposes for the rented board games, for which the deposit amount may or may not be charged partially or in full;
in the case one or more board games have been selected for rental, add the selected board games to a rental cart and in the case one or more board games have been selected for purchase, add the selected board games to a purchase cart;
display user's carts split by rental cart and purchase cart;
upon acceptance of user inputs to either rent or purchase the desired board games, update the inventory of board games available for rent for the selected date or dates and/or purchase stored thereon;
communicate with a designated product delivery service either internal or external to retrieve the selected products from the product storage facility and deliver the selected products to the user's selected address by the selected reservation date for rentals or delivery date for purchases with the selected method and timeframe, and to pick up the products after the rental period at the user's selected address with the selected method and timeframe; and
update the inventory of board games available for rent once the board games have been returned to the board game storage facility.

2. The online integrated board game rental and purchase system according to claim 1, wherein the computer system is programmed to
provide a wish list to provide users dual options to add a selected board game to the wish list for rental purposes with a requested reservation date or dates or for purchase purposes,
notify the user when a board game in the wish list for rental purposes becomes available for rental at the requested date or dates or when a board game in the wish list for purchase purposes becomes available for purchase, and
accept user input to add the board games in wish list to either the rental or purchase cart when the board games become available at the requested date or dates for rental or available for purchase and accept user's input to either rent or purchase the board games in wish list.

3. The online integrated board game rental and purchase system according to claim 1, wherein the computer system is programmed to
allow users to create rental reservations to rent board games and/or purchase reservations to purchase board games, and
display users' reservations split by rental reservations and purchase reservations, and also by past or completed reservations.

4. The online integrated board game rental and purchase system according to claim 1, wherein the computer system is programmed to
allow the user in the rental or purchase reservation to modify the address, method and timeframe for delivery or return purposes, remove or change amount of board games, to cancel the reservation, to view receipt of the reservation, to leave a tip and to end the rental reservation.

5. The online integrated board game rental and purchase system according to claim 1, wherein the computer system is programmed to
displaying calendars and allowing the user input to select a reservation date and duration, which determines the requested rental date or dates,
display the rental availability while browsing based on the requested rental date or dates, and
upon change of the reservation date and/or duration on any rental calendar, update all rental calendars using the selected reservation date and duration, update the rental availability when browsing through the board games based on the new requested date or dates, wherein the rental availability of each individual board game depends on the available rental inventory of that board game and existing rental reservations containing that board game that have an overlapping rental period as the requested rental date or dates of the user.

6. The online integrated board game rental and purchase system according to claim 1, wherein the computer system is programmed to
display in a calendar with the combined availability of all board games added to the rental cart in order to allow the user to select a date that will allow the user to rent all board games selected by the user in the rental cart, and
accept user input to select board games that are or are not currently available at the selected date and duration to rent, and thereafter search the calendar of combined availability to select a reservation date or dates that results in all board games being available.

7. The online integrated board game rental and purchase system according to claim 1, wherein the computer system is programmed to
allow users, upon finalizing rental of one or more board games and checking out, to either make a new rental reservation, add the rented board games to a pending rental reservation, if any, or to add the rented board games to an ongoing rental reservation, if any, wherein the process of checking out differs depending on the choice selected by the user where ending rental reservation is defined as a rental reservation that has not started yet while ongoing rental reservation is defined as a rental reservation that has started, and
allow users, upon finalizing purchase of one or more board games and check out, to either make a new purchase reservation or add the purchased board games to a pending purchase reservation, if any, wherein the process of checking out differs depending on the choice selected by the user, wherein a pending purchase reservation is defined as a purchase reservation whose delivery process has not been initiated yet on the requested delivery date.

8. The online integrated board game rental and purchase system according to claim 1, wherein the computer system is programmed to
display, once one or more board games have been selected for rent or purchase, a list of “warnings” detailing specific requirements, if any, of the selected board games, and
prompt the user to acknowledge these “warnings” before being able to complete the checkout process.

9. The online integrated board game rental and purchase system according to claim 1, wherein the computer system is programmed to
allow the user to modify the reservation date of the rented board games in a pending rental reservation, and before a modification is made, display a calendar with the combined availability of all board games in the rental reservation to show alternate reservation dates possible for the user to choose to rent the selected board games.

10. The online integrated board game rental and purchase system according to claim 1, wherein the computer system is programmed to
calculate and assign membership points to the user based on a predetermined formula for calculating membership points,
display status of user's membership points, such as outstanding membership points, redeemed membership points and earned/credited membership points,
display available reservation dates following the last date of a rental reservation and allow the user to extend the rental reservation if available, wherein the availability of extension is based on the availability of rental inventory of each board game in the rental reservation, as well as existing reservations that contain at least one of the board games in the user's rental reservation and whose reservation period overlaps the user's rental reservation requested date or dates for extension,
provide an option of paying directly for the extension of time by paying the extension of time fee or by redeeming membership points, if sufficient membership points where the amount of membership points required to redeem the extension of time is displayed with user's outstanding membership points, and
update dates and receipt in the rental reservation after extension has been finalized.

11. The online integrated board game rental and purchase system according to claim 1, wherein the computer system is programmed to
display an interactive checklist for each board game in the rental reservation which includes a list of items that represent all components of the board game and each item is described with an “amount”, a “description” and a “location”,
providing a list of actions in the checklist that the user can optionally take prior to the end of the rental reservation,
allow the user to fill the checklist by selecting one of the status designations available for each of the items or the actions, such as “Complete”, “Missing”, “Damaged” or “Done”, and
upon the user completing the entire checklist including a status entered for each item and action, assigning the user bonus membership points or other forms of bonus or rewards.

12. The online integrated board game rental and purchase system according to claim 1, wherein the computer system is programmed to
upon receipt of the checklist filled out by the user, send an internal notification about missing or damaged items or other issues for timely replacement of the missing or damaged items or any parts before the next reservation, if possible.

13. The online integrated board game rental and purchase system according to claim 1, wherein the online integrated board game rental and purchase system is accessible by a mobile application downloadable onto smart devices connected to the internet.

14. An online integrated rental and purchase system for products, comprising:
a storage facility for the products;
a computer system and data base comprising a memory with an inventory of products available for rent and/or purchase stored thereon;
the computer system is accessible online by a mobile application and online by remote computers via a website and being programmed to
permit browsing of the inventory of products by different categories and criteria,
accept user inputs related to preferred date or dates for rental or purchase of desired products,
display availability of each product for rental on the preferred date or dates and availability for purchase,
display availability of related or dependable products, if any, to each product, such as add-ons that requires the product to use the related or dependable products, for rental on the preferred date or dates for ability to rent several products together,
accept user inputs to either rent or purchase the desired products for a selected rental period if the products are available on the selected date or dates for the selected rental period or if the products are available for purchase,
accept user inputs to provide address, method and timeframe to which the rented or purchased products which are selected are to be delivered to and address, method and timeframe to which the rented products which are selected are to be picked up for return purposes;
accept user inputs to provide credit card information to pay to rent or purchase products or for deposit purposes for the rented products, for which the deposit amount may or may not be charged partially or in full;
in the case one or more products have been selected for rental, add the selected products to a rental cart and in the case one or more products have been selected for purchase, add the selected products to a purchase cart;
display user's carts split by rental cart and purchase cart;
upon acceptance of user inputs to either rent or purchase the desired products, update the inventory of products available for rent for the selected date or dates and/or purchase stored thereon;
communicate with a designated product delivery service either internal or external to retrieve the selected products from the product storage facility and deliver the selected products to the user's selected address by the selected delivery date with the selected method and timeframe, and to pick up the products after the rental period at the user's selected address with the selected method and timeframe; and
update the inventory of products available for rent once the products have been returned to the storage facility.

15. The online integrated rental and purchase system according to claim 14, wherein the computer system is programmed to
provide a wish list to provide users dual options to add a selected product to the wish list for rental purposes with a requested reservation date or dates or for purchase purposes,
notify the user when a product in the wish list for rental purposes becomes available for rental at the requested date or dates or when a product in the wish list for purchase purposes becomes available for purchase, and
accept user input to add the products in wish list to either the rental or purchase cart when the products become available at the requested date or dates for rental or available for purchase and accept user's input to either rent or purchase the products in wish list.

16. The online integrated rental and purchase system according to claim 14, wherein the computer system is programmed to
display, once one or more products have been selected for rent or purchase, a list of “warnings” detailing specific requirements, if any, of the selected products,
prompt the user to acknowledge these “warnings” before being able to complete the checkout process,
allow users to create rental reservations to rent products and/or purchase reservations to purchase products,
allow users, upon finalizing rental of one or more products and checking out, to either make a new rental reservation, add the rented products to a pending rental reservation, if any, or to add the rented products to an ongoing rental reservation, if any, wherein the process of checking out differs depending on the choice selected by the user. Pending rental reservation is defined as a rental reservation that has not started yet while ongoing rental reservation is defined as a rental reservation that has started. The rental reservation will start on the first selected date of the rental reservation,
allow users, upon finalizing purchase of one or more products and check out, to either make a new purchase reservation or add the purchased products to a pending purchase reservation, if any, wherein the process of checking out differs depending on the choice selected by the user. Pending purchase reservation is defined as a purchase reservation whose delivery process has not been initiated yet on the requested delivery date,
display users' reservations split by rental reservations and purchase reservations, and also by past or completed reservations, and
allow the user in the rental or purchase reservation to modify the address, method and timeframe for delivery or return purposes, remove or change amount of board games, to cancel the reservation, to view receipt of the reservation, to leave a tip and to end the rental reservation.

17. The online integrated rental and purchase system according to claim 14, wherein the computer system is programmed to
display in a calendar with the combined availability of all products added to the rental cart in order to allow the user to select a date that will allow the user to rent all products selected by the user in the rental cart,
accept user input to select products that are or are not currently available at the selected date and duration to rent, and thereafter search the calendar of combined availability to select a reservation date or dates that results in all products being available, and
allow the user to modify the reservation date of the rented products in a pending rental reservation, and before a modification is made, display a calendar with the combined availability of all products in the rental reservation to show alternate reservation dates possible for the user to choose to rent the selected products.

18. The online integrated rental and purchase system according to claim 14, wherein the computer system is programmed to
calculate and assign membership points to the user based on a predetermined formula for calculating membership points,
display status of user's membership points, such as outstanding membership points, redeemed membership points and earned/credited membership points,
display available reservation dates following the last date of a rental reservation and allow the user to extend the rental reservation if available, wherein the availability of extension is based on the availability of rental inventory of each product in the rental reservation, as well as existing reservations that contain at least one of the products in the user's rental reservation and whose reservation period overlaps the user's rental reservation requested date or dates for extension,
provide an option of paying directly for the extension of time by paying the extension of time fee or by redeeming membership points, if sufficient membership points where the amount of membership points required to redeem the extension of time is displayed with user's outstanding membership points, and
updated dates and receipt in the rental reservation after extension has been finalized.

19. The online integrated rental and purchase system according to claim 14, wherein the computer system is programmed to
display an interactive checklist for each product in the rental reservation which includes a list of items that represent all components of the product and each item is described with an “amount”, a “description” and a “location”,
providing a list of actions in the checklist that the user can optionally take prior to the end of the rental reservation,
allow the user to fill the checklist by selecting one of the status designations available for each of the items or the actions, such as “Complete”, “Missing”, “Damaged” or “Done”,
upon the user completing the entire checklist including a status entered for each item and action, assigning the user bonus membership points or other forms of bonus or rewards, and
upon receipt of the checklist filled out by the user, send an internal notification about missing or damaged items or other issues for timely replacement of the missing or damaged items or any parts before the next reservation, if possible.
